(19) United States
(12) Patent Application Publication
(10) Pub. No.: US 2018/0079296 A1
(43) Pub. Date: Mar. 22, 2018

(54) FUEL FILLER STRUCTURE OF FUEL SUPPLY PIPE

(71) Applicant: HONDA MOTOR CO., LTD., TOKYO (JP)

(72) Inventors: Masaki WAKAO, WAKO-SHI (JP); Hiroshi KITAMURA, TORRANCE, CA (US)

(21) Appl. No.: 15/269,194

(22) Filed: Sep. 19, 2016

(51) Int. Cl. B60K 15/04

(52) U.S. Cl. CPC B60K 15/04; B60K 2015/048

(57) ABSTRACT

A fuel filler structure includes a cylindrical part having a fueling port and a connecting port; a first flap mechanism and a second flap mechanism that are disposed close to the fueling port and the connecting port of the cylindrical part, respectively, and when a nozzle is inserted through the fueling port, the respective flap mechanisms are pressed by the nozzle to open the fueling port and an opening on the connecting port side; a drain hole formed in the cylindrical part and allowing the inside of the cylindrical part to be communicated with the outside; and an opening and closing valve for opening and closing the drain hole. The opening and closing valve includes a valve mechanism that maintains a closed state of the drain hole through negative pressure suction by a volatile fuel suction mechanism attached to the nozzle.

### BACKGROUND OF THE INVENTION

### 1. Field of the Invention

The present invention relates to a fuel filler structure of a fuel supply pipe that makes communication and connection between a fueling port and a fuel tank.

### 2. Description of the Related Art

A vehicle such as an automobile or the like provided with an internal-combustion engine is provided with a fuel supply pipe that makes communication and connection between a fueling port through which a nozzle of a fueling gun is inserted, and a fuel tank in which fuel is accumulated. Moreover, in recent years, what is called a cap-less fuel filler structure that eliminates the use of a fuel cap conventionally provided at the fueling port has been adopted, in order to improve convenience at the time of fueling.

For example, Patent document 1 (Japanese Unexamined Patent Application Publication No. 2015-071408) discloses a cap-less fuel filler structure, and the fuel filler structure is provided with an outside cover having the form of a cylinder. Formed in the outside cover is a drain hole for draining water, dust or the like that enters the internal space of the outside cover, to the outside.

Incidentally, a fueling device equipped at a gas station is, in some cases, provided with a suction mechanism that is adapted to suck volatile fuel into a tank at the gas station simultaneously with the fueling, in order to suppress emission of the volatile fuel to the atmosphere during the fueling.

When the fueling device provided with the suction mechanism is used to carry out the fueling, the above cap-less fuel filler structure allows the atmospheric air to be sucked at the same time through the drain hole communicated with the outside, thus leading to a risk that an efficiency of suction of the volatile fuel is decreased.

### SUMMARY OF THE INVENTION

A general object of the present invention is to provide a fuel filler structure of a fuel supply pipe, capable of suppressing a decrease in efficiency of suction of volatile fuel during the fueling even where a drain hole is provided.

In order to achieve the above object, the present invention provides a fuel filler structure of a fuel supply pipe, including: a cylindrical part that has an opening through which a nozzle of a fueling gun is inserted, and a connecting port to which a fuel supply pipe for supplying fuel to a fuel tank is connected, the cylindrical part having a drain hole formed therein, the drain hole allowing an inside of the cylindrical part to be communicated with an outside of the cylindrical part; a flap mechanism that is disposed close to the opening of the cylindrical part and configured to be pressed by the nozzle to open the opening when the nozzle is inserted through the opening; and an opening and closing valve that is configured to open and close the drain hole, the opening and closing valve including a valve mechanism that is configured to maintain a closed state of the drain hole through negative pressure suction by a volatile fuel suction mechanism attached to the nozzle.

The present invention allows a fuel filler structure of a fuel supply pipe to be obtained that is capable of suppressing a decrease in efficiency of suction of volatile fuel during the fueling even where a drain hole is provided.

### BRIEF DESCRIPTION OF THE DRAWINGS

FIG. 1 is an enlarged cross-sectional view, but partly omitted, showing a fuel filler structure according to an embodiment of the present invention.

FIG. 2A and FIG. 2B are enlarged cross-sectional views for explaining a structure of a valve element and a way of attaching the valve element to a valve element attaching part, and FIG. 2C is an enlarged cross-sectional view showing a valve-open state in which the valve element is moved away from a seating part.

FIG. 3 is an enlarged cross-sectional view, but partly omitted, showing a state in which the valve element is moved away from the seating part through liquid pressure of liquid accumulated in a liquid accumulating part, thereby draining the liquid to the outside.

FIG. 4A is a cross-sectional view showing a state before fueling in the present embodiment, and FIG. 4B is a cross-sectional view showing a state in which volatile fuel is sucked by a volatile fuel suction mechanism during the fueling.

FIG. 5A is a cross-sectional view showing a state before fueling in a comparative example devised by the present applicant, and FIG. 5B is a cross-sectional view showing a state in which volatile fuel is sucked by a volatile fuel suction mechanism during the fueling.

### DETAILED DESCRIPTION OF THE PREFERRED EMBODIMENTS

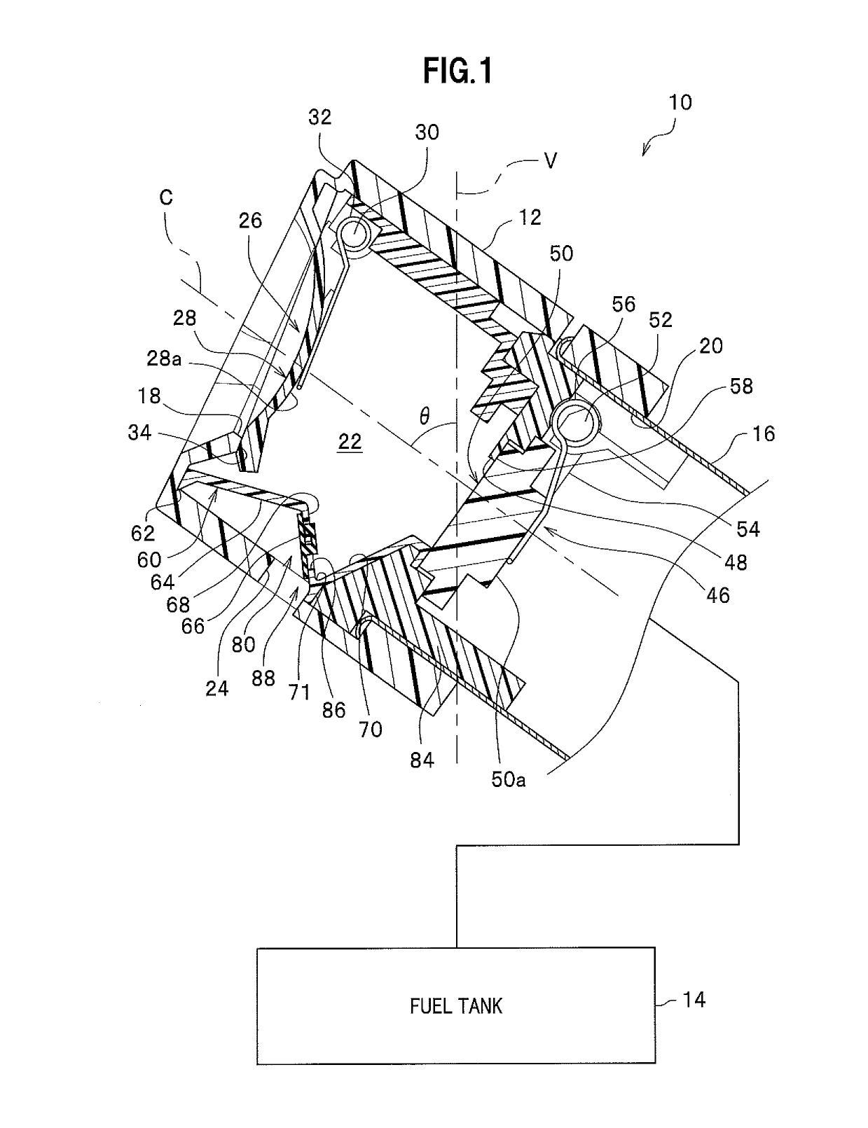

Embodiments of the present invention will be hereinafter described in detail with reference to the drawings as appropriate. FIG. 1 is an enlarged cross-sectional view, but partly omitted, showing a fuel filler structure according to an embodiment of the present invention.

A fuel feeding part (not shown) is provided in a predetermined place of a vehicle. The fuel feeding part is provided with a nearly disk-shaped lid part (not shown), and a hinge part (not shown) that allows the lid part to rotate so as to be freely opened and closed. The lid part is adapted to maintain the closed state (locked state) of the lid part, and to be brought into an unlocked state by operation of an unlocking lever provided in a vehicle interior. In the unlocked state, the lid part rotates by a predetermined angle around the hinge part as the rotation center, to be switched from the closed state to the opened state.

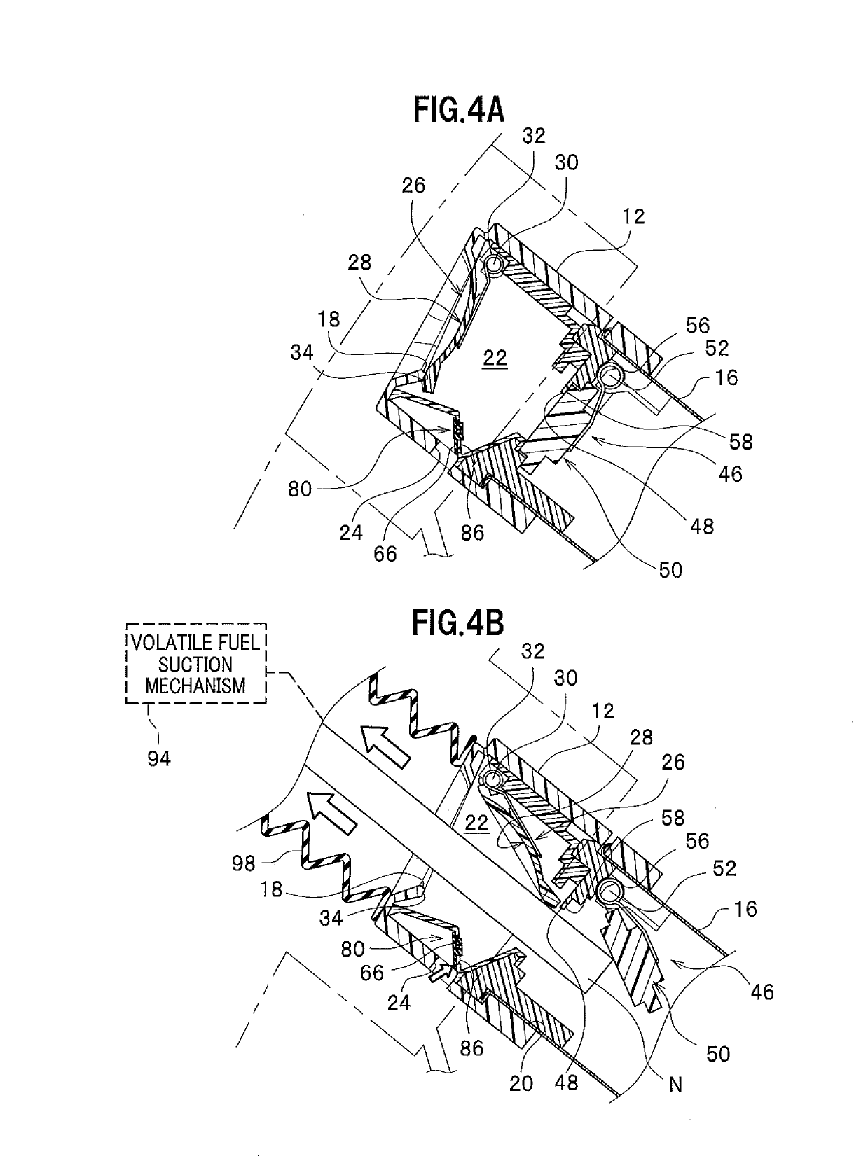

As shown in FIG. 1, a fuel filler structure 10 according to the embodiment of the present invention is applied to the fuel feeding part (not shown), and is provided with a cylindrical part 12, and a filler pipe (fuel supply pipe) 16 for supplying fuel fed through the cylindrical part 12 to a fuel tank 14. The cylindrical part 12 includes a fueling port (opening) 18 through which a nozzle N (see FIG. 4B) of a fueling gun (not shown) is inserted, and a connecting port 20 to which the filler pipe 16 for supplying fuel to the fuel tank 14 is connected. Note that in the fuel filler structure 10 according to the present embodiment, the cylindrical part 12 is disposed to allow the center line C thereof to be inclined by a predetermined angle θ relative to the vertical line V.

An internal space section 22 that allows the fueling port 18 to be communicated with the connecting port 20 is provided between the fueling port 18 and the connecting port 20 along an axial direction of the cylindrical part 12. Moreover, a drain hole 24 that allows the internal space section 22 to be communicated with the outside is formed in a middle part of the cylindrical part 12. The drain hole 24 is formed into a through-hole. The drain hole 24 is provided for draining water (moisture) or the like that enters the internal space section 22 of the cylindrical part 12, to the outside. Note that water or moisture contains dust or the like in some cases.

A first flap mechanism (one flap mechanism) 26 is disposed close to the fueling port 18 of the cylindrical part 12. The first flap mechanism 26 is adapted to open and close the fueling port 18 when carrying out the fueling. For example, when the nozzle N of the fueling gun (not shown) is inserted through the fueling port 18 as described later, the flap mechanism is pressed by the tip of the nozzle N to open the fueling port 18.

The first flap mechanism 26 includes a first shutter member 28 that opens and closes the fueling port 18 of the cylindrical part 12, a first hinge part 30 that constitutes a rotating shaft of the first shutter member 28, and a first spring member 32 that is hooked on the first hinge part 30 to urge the first shutter member 28 into the closed state.

The first shutter member 28 includes a shutter body 28a having the form of nearly a disk, and is provided to be rotatable around the first hinge part 30 as the rotation center, which is disposed on one side of the shutter body 28a. Rotating action of the first shutter member 28 causes switching between the closed state in which the shutter body 28a abuts on a first seating part 34 provided at a lower part of the fueling port 18 to close the fueling port 18, and the opened state in which the shutter body 28a is moved away from the first seating part 34 to open the fueling port 18.

A second flap mechanism (another flap mechanism) 46 is disposed close to the connecting port 20 of the cylindrical part 12. The second flap mechanism 46 is adapted to open and close an opening 48 on the connecting port side when carrying out the fueling. For example, when the nozzle N of the fueling gun (not shown) is inserted through the fueling port 18 as described later, the flap mechanism is pressed by the tip of the nozzle N to open the opening 48 on the connecting port side (see FIG. 4B). Thus, the second flap mechanism 46 is disposed close to the connecting port 20 of the cylindrical part 12, thereby making it possible to reliably prevent entry of dust or the like into the filler pipe 16 and the fuel tank 14.

The second flap mechanism 46 includes a second shutter member 50 that opens and closes the opening 48 on the connecting port side, a second hinge part 52 that constitutes a rotating shaft of the second shutter member 50, an arm part 54 that connects the second shutter member 50 with the second hinge part 52, and a second spring member 56 that is hooked on the second hinge part 52 to urge the second shutter member 50 into the closed state.

The second shutter member 50 includes a shutter body 50a having an annular stepped portion formed thereon, and is provided to be rotatable around the second hinge part 52 as the rotation center, which is disposed on one side of the shutter body 50a. Rotating action of the second shutter member 50 causes switching between the closed state in which the shutter body 50a abuts on a second seating part 58 provided at a lower part of the opening 48 on the connecting port side to close the opening 48 on the connecting port side, and the opened state in which the shutter body 50a is moved away from the second seating part 58 to open the opening 48 on the connecting port side.

A first inside member 60 that is attached on an inner surface of the cylindrical part 12 is disposed in the internal space section 22 of the cylindrical part 12. The first inside member 60 includes a locking part 62, a depressed part 64, a valve element attaching part 68 to which a valve element 66 to be described later is attached, and a liquid accumulating part 70.

The locking part 62 is provided at a place near the fueling port 18 and has a nearly annular locking claw that is locked on the inner surface of the cylindrical part 12. The depressed part 64 is formed to extend inward (toward the side opposite to the fueling port 18) from the locking part 62 and to allow a distance away from the inner surface of the cylindrical part 12 to gradually increase to be inwardly depressed. The depressed part 64 is formed to constitute an inclined wall that is inclined by a predetermined angle, at a portion along the circumferential direction of the first inside member 60. The liquid accumulating part 70 is located below the depressed part 64 and has a bottom wall 71 that is bent into a nearly V shape in cross-section between the valve element attaching part 68 and the bottom wall 71. Water (moisture) or the like entering the internal space section 22 through the fueling port 18 is accumulated in the liquid accumulating part 70.

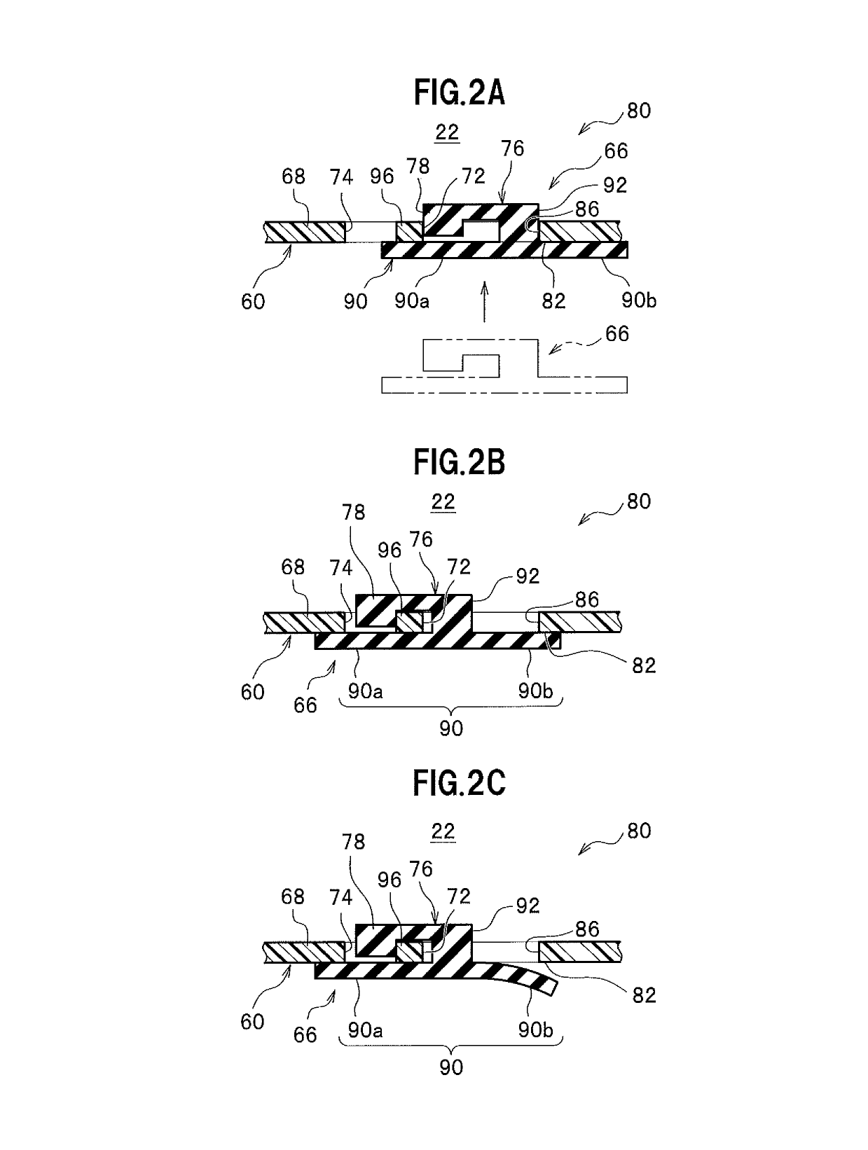

FIG. 2A and FIG. 2B are enlarged cross-sectional views showing a structure of the valve element.

As shown in FIG. 2A and FIG. 2B, the valve element attaching part 68 has a hole for insertion 72 and a hole for hooking 74 formed therein, respectively. The hole for insertion 72 is a hole for allowing a part to be attached (hereinafter, called “to-be-attached part”) 76 of the valve element 66 to be described later, to be inserted into the internal space section 22 from the outside and then allowing the to-be-attached part 76 to slide therein. The hole for insertion 72 is formed to correspond to a shape of the to-be-attached part 76 in planar view. The hole for hooking 74 is a hole for allowing a hook part 78 of the valve element 66 to be described later, to deform elastically when the to-be-attached part 76 slides and allowing the hook part 78 to be caught and locked on a wall 96 to be described later.

Thus, the first inside member 60 combines a seating part forming function for forming a seating part 82 of a valve mechanism 80 to be described later, a support function of supporting the rotating shaft of the first shutter member 28, and a support function of supporting the valve element 66 of the valve mechanism 80.

A second inside member 84 that is attached on the inner surface of the cylindrical part 12 is disposed between the drain hole 24 and the connecting port 20 of the cylindrical part 12. The second inside member 84 has the opening 48 on the connecting port side and the second seating part 58 formed therein. Moreover, the filler pipe 16 is held between the cylindrical part 12 on the outer side and the second inside member 84 on the inner side. The second inside member 84 combines a function of connecting the filler pipe 16 to the connecting port 20, and a support function of supporting the rotating shaft of the second flap mechanism 46.

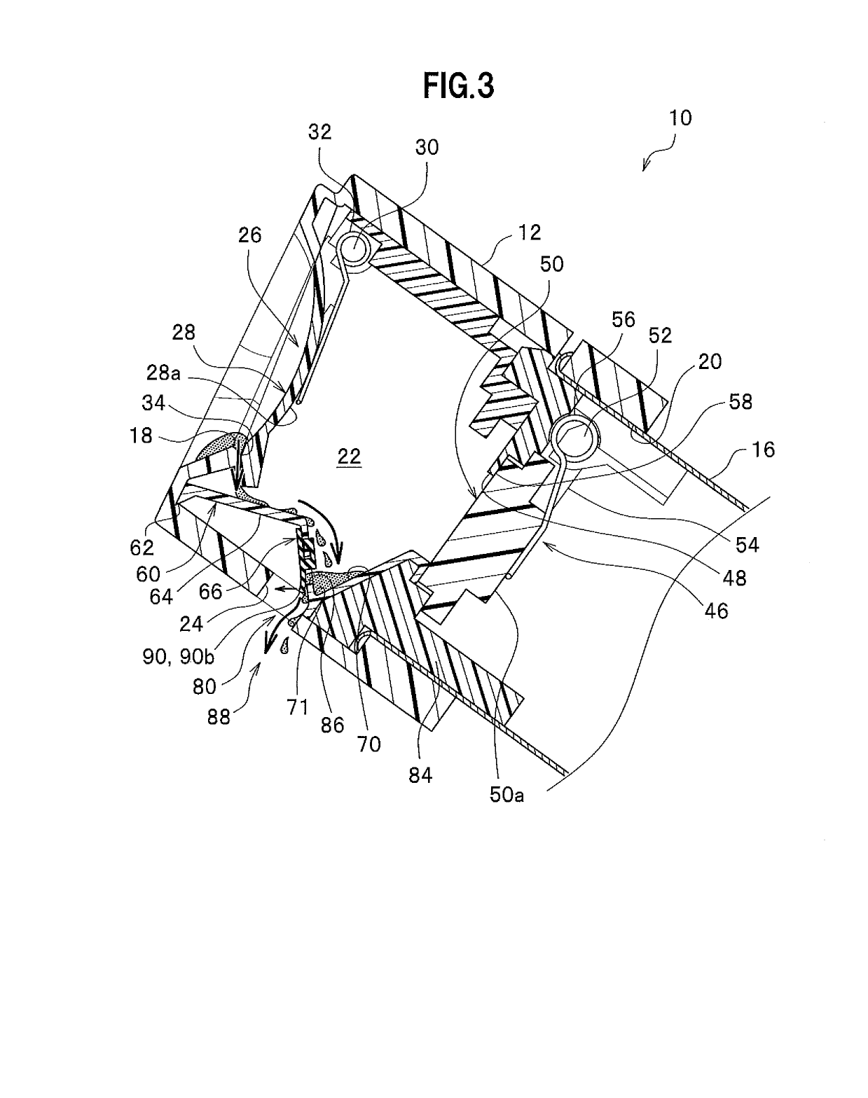

An opening and closing valve 88 that is configured to open and close a communication hole 86 communicated with the drain hole 24 is disposed between the depressed part 64 of the first inside member 60 and the liquid accumulating part 70. The opening and closing valve 88 includes the valve mechanism 80. The valve mechanism 80 is adapted to open the communication hole 86 communicated with the drain hole 24 to drain water (moisture), dust or the like entering the internal space section 22, through the communication hole 86 and the drain hole 24 to the outside (see FIG. 3). Note that the communication hole 86 and the hole for insertion 72 are substantially the same hole, which serves as the communication hole 86 when water (moisture) accumulated in the liquid accumulating part 70 is drained, and serves as the hole for insertion 72 when the valve element 66 is attached.

The valve mechanism 80 includes the valve element 66 that is attached to the valve element attaching part 68 of the first inside member 60, and the seating part 82 on which the valve element 66 is seated. The valve element 66 includes a valve body 90 that faces the drain hole 24 (the outer wall side of the first inside member 60), and the to-be-attached part 76 that faces the internal space section 22 (the inner wall side of the first inside member 60). The valve body 90 and the to-be-attached part 76 are integrally formed of, for example, elastic material such as rubber. The valve body 90 is shaped, for example, in the form of nearly a disk in planar view. The valve body 90 is not limited to the form of a disk, but may have, for example, an oval shape or a rectangular shape. The to-be-attached part 76 includes a connection part 92 that is connected to an upper surface of the valve body 90, and the hook part 78 that extends nearly parallel to the valve body 90 from the connection part 92 and is bent into a nearly L shape in cross-section.

The valve body 90 is composed of a one-side portion 90a that starts from the connection part 92 to face the to-be-attached part 76, and an other-side portion 90b that starts from the connection part 92 not to face the to-be-attached part 76. The other-side portion 90b is formed so as to be moved away from the seating part 82 to be elastically deformable (see FIG. 2C). In this case, for example, using a two-color molding method, the one-side portion 90a of the valve body 90 made of a hard rubber and the other-side portion 90b made of a soft rubber can be formed integral with each other.

Next, description will be roughly given of a way of attaching the valve element to the valve element attaching part.

FIG. 2A and FIG. 2B are enlarged cross-sectional views for explaining a way of attaching the valve element to the valve element attaching part.

The to-be-attached part 76 of the valve element 66 is inserted in the direction of arrow (see FIG. 2A) through the hole for insertion 72 of the valve element attaching part 68 of the first inside member 60, and the to-be-attached part 76 is allowed to slide toward the hole for hooking 74. When the to-be-attached part 76 is allowed to slide, the hook part 78 elastically deforms upward to climb over the wall 96 formed between the hole for insertion 72 and the hole for hooking 74, and the hook part 78 is caught and locked on the wall 96 (see FIG. 2B). Note that when the valve element 66 is attached on the valve element attaching part 68, the valve element 66 (the other-side portion 90b of the valve body 90) is seated on the seating part 82 to be brought into a valve-closed state.

The fuel filler structure 10 according to the present embodiment is basically configured as described above, and operations and effects thereof will be described below. FIG. 2C is an enlarged cross-sectional view showing a valve-open state in which the valve element is moved away from the seating part, and FIG. 3 is an enlarged cross-sectional view, but partly omitted, showing a state in which the valve element is moved away from the seating part through liquid pressure of liquid accumulated in the liquid accumulating part, thereby draining the liquid to the outside.

The valve element 66 constituting the valve mechanism 80 is seated on the seating part 82 under the valve element 66's own weight in a normal state to be brought into the valve-closed state. As shown in FIG. 1, the cylindrical part 12 is disposed to allow the center line C thereof to be inclined by the predetermined angle θ relative to the vertical line V, and the seating part 82 is provided along a nearly vertical up-down direction. Moreover, the one-side portion 90a of the valve body 90 is located on the upper side in the vertical direction and the other-side portion 90b of the valve body 90 is located on the lower side in the vertical direction. Adoption of such configuration structure makes it possible to allow the other-side portion 90b of the valve body 90 to properly block the communication hole 86 under the valve element 66's own weight. Note that, in the normal state, the valve element 66 is seated on the seating part 82 to allow the communication hole 86 to be blocked, thus keeping a non-communicated state between the internal space section 22 and the outside. This prevents water (moisture), dust or the like from entering the internal space section 22 of the cylindrical part 12.

Moreover, as shown in FIG. 3, water (moisture) (see a dotted portion in FIG. 3) entering the internal space section 22 through the fueling port 18 is accumulated in the liquid accumulating part 70. Liquid pressure of the water (moisture) accumulated in the liquid accumulating part 70 causes the other-side portion 90b of the valve element 66 (valve body 90) to deform elastically and move away from the seating part 82 to be brought into the valve-open state (see FIG. 2C). This allows the water (moisture) accumulated in the liquid accumulating part 70 to be drained through the communication hole 86 and the drain hole 24 to the outside (see FIG. 3). Note that, after the water (moisture) is drained, the other-side portion 90b of the valve element 66 (valve body 90) is seated on the seating part 82 through its elastic force.

Furthermore, at the time of fueling, the valve element 66 is maintained at a valve-closed state in which it is seated on the seating part 82, through negative pressure suction by a volatile fuel suction mechanism 94 attached to the nozzle N (see FIG. 4B to be described later). Although the valve element 66 is in the state of being seated on the seating part 82 under the valve element 66's own weight in the normal state, application of suction pressure from the volatile fuel suction mechanism 94 thereto causes the valve element 66 to be pressed against the seating part 82. This enables sealing performance to be further increased. As a result, the present embodiment makes it possible to suppress a decrease in efficiency of suction of the volatile fuel during the fueling.

Next, description will be given of a case where a fueling device provided with the volatile fuel suction mechanism 94 is used to carry out the fueling, the volatile fuel suction mechanism 94 being adapted to suck volatile fuel into a tank equipped at a gas station simultaneously with the fueling, in order to suppress emission of the volatile fuel to the atmosphere during the fueling.

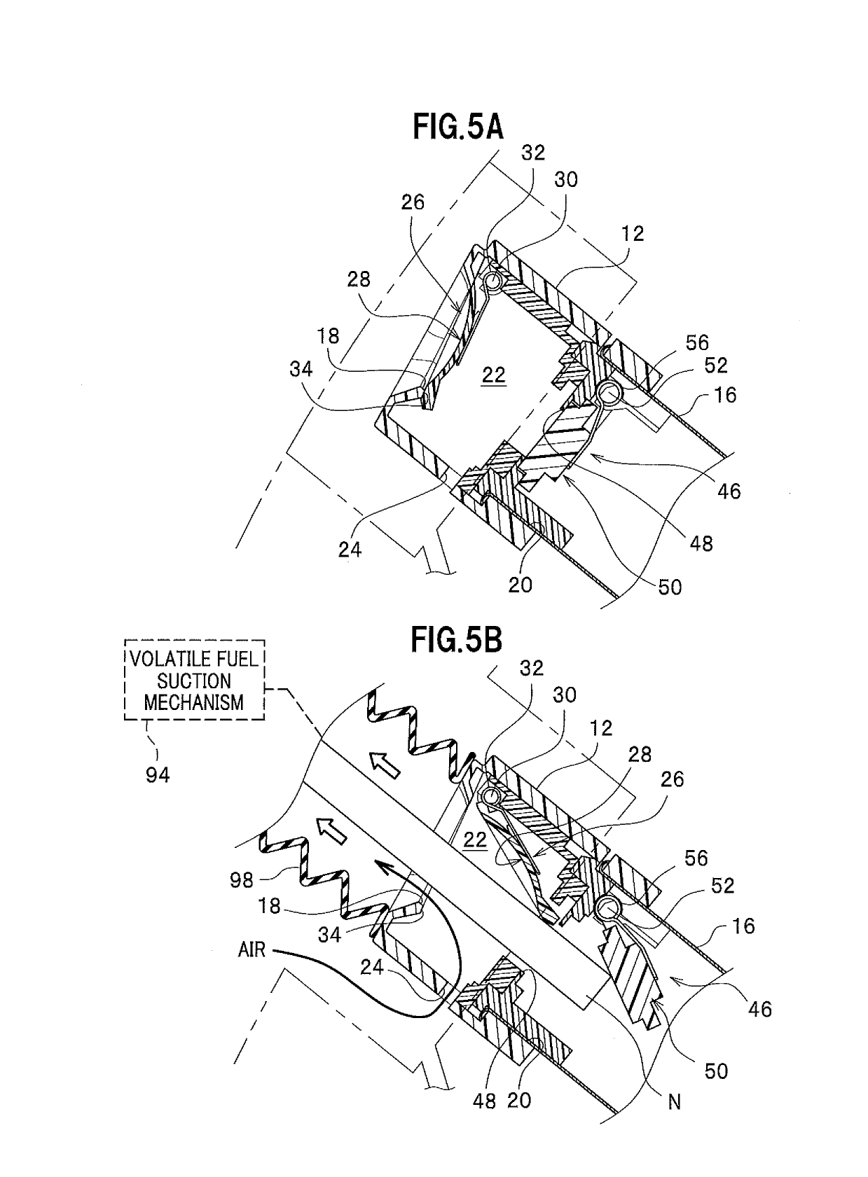

FIG. 4A is a cross-sectional view showing a state before fueling in the present embodiment, and FIG. 4B is a cross-sectional view showing a state in which the volatile fuel is sucked by the volatile fuel suction mechanism 94 during the fueling. Moreover, FIG. 5A is a cross-sectional view showing a state before fueling in a comparative example devised by the present applicant, and FIG. 5B is a cross-sectional view showing a state in which the volatile fuel is sucked by the volatile fuel suction mechanism 94 during the fueling. Note that in FIG. 4B and FIG. 5B, reference numeral 98 denotes a bellows portion made of rubber covering the nozzle N.

When the nozzle N of the fueling gun (not shown) is inserted through the fueling port 18, the tip of the nozzle N allows the first shutter member 28 and the second shutter member 50 to be pressed obliquely upward, respectively (see FIG. 4A and FIG. 4B by comparison). As shown in FIG. 4B, the first shutter member 28 acts against a spring force of the first spring member 32 to rotate counterclockwise by a predetermined angle around the first hinge part 30 as the rotation center. The first shutter member 28 is moved away from the first seating part 34, thereby allowing the first flap mechanism 26 to bring the fueling port 18 into the opened state.

Moreover, the second shutter member 50 acts against a spring force of the second spring member 56 to rotate counterclockwise by a predetermined angle around the second hinge part 52 as the rotation center. The second shutter member 50 is moved away from the second seating part 58, thereby allowing the second flap mechanism 46 to bring the opening 48 on the connecting port side into the opened state.

When the fueling work is completed and the nozzle N is pulled out of the fueling port 18, the first shutter member 28 and the second shutter member 50 are seated, through the spring forces of the first spring member 32 and the second spring member 56, on the first seating part 34 and the second seating part 58 to return to the original points, respectively.

The comparative example devised by the present applicant is configured with the same structure as that in the present embodiment, except for the opening and closing valve 88 (including the valve mechanism 80) disposed in the present embodiment. Accordingly, in the comparative example, the same constituent element as that in the present embodiment is given the same reference sign and thus detailed description thereof will be omitted.

In the comparative example, where the fueling device provided with the volatile fuel suction mechanism 94 that sucks volatile fuel simultaneously with the fueling is used to carry out the fueling, the atmospheric air is sucked at the same time through the drain hole 24 communicated with the outside, thus leading to a risk that an efficiency of suction of the volatile fuel is decreased (see outlined arrows in FIG. 5B).

While on the other hand, in the present embodiment as shown in FIG. 4B, the valve element 66 of the valve mechanism 80 is pressed against the seating part 82 under application of suction pressure from the volatile fuel suction mechanism 94 during the fueling, thereby being maintained at the valve-closed state in which the communication hole 86 is closed.

Consequently, in the present embodiment, where the fueling device provided with the volatile fuel suction mechanism 94 that sucks volatile fuel simultaneously with the fueling is used to carry out the fueling, the valve element 66 of the valve mechanism 80 allows the drain hole 24 to be maintained at the closed state, thus making it possible to properly avoid a decrease in efficiency of suction of the volatile fuel during the fueling. As a result, the present embodiment makes it possible to increase the amount of suction of the volatile fuel during the fueling, as compared to the comparative example (see outlined arrows in FIG. 4B).

### DESCRIPTION OF REFERENCE SIGNS

10: Fuel filler structure; 12: Cylindrical part; 14: Fuel tank; 16: Filler pipe (Fuel supply pipe); 18: Fueling port (Opening); 20: Connecting port; 24: Drain hole; 26: First flap mechanism (Flap mechanism); 80: Valve mechanism; 88: Opening and closing valve; 94: Volatile fuel suction mechanism; N: Nozzle

What is claimed is:

1. A fuel filler structure of a fuel supply pipe, comprising:
a cylindrical part that has an opening through which a nozzle of a fueling gun is inserted, and a connecting port to which a fuel supply pipe for supplying fuel to a fuel tank is connected, the cylindrical part having a drain hole formed therein, the drain hole allowing an inside of the cylindrical part to be communicated with an outside of the cylindrical part;
a flap mechanism that is disposed close to the opening of the cylindrical part and configured to be pressed by the nozzle to open the opening when the nozzle is inserted through the opening; and
an opening and closing valve that is configured to open and close the drain hole,
the opening and closing valve including a valve mechanism that is configured to maintain a closed state of the drain hole through negative pressure suction by a volatile fuel suction mechanism attached to the nozzle.

2. The fuel filler structure of the fuel supply pipe, according to claim 1, further comprising
a liquid accumulating part that is provided inside the cylindrical part and configured to accumulate therein water or moisture that enters through the opening, wherein
the valve mechanism is brought into a valve-open state through liquid pressure of liquid accumulated in the liquid accumulating part.
